(19) United States
(12) Patent Application Publication
(10) Pub. No.: US 2007/0059025 A1
(43) Pub. Date: Mar. 15, 2007

(54) Image forming apparatus which can prevent toner from scattering

(75) Inventor: Seung-gweon Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/501,732

(22) Filed: Aug. 10, 2006

(30) Foreign Application Priority Data
Sep. 12, 2005 (KR) 10-2005-0084646

(51) Int. Cl. G03G 21/00

(52) U.S. Cl. 399/98

(57) ABSTRACT

An image forming apparatus includes a structure which can prevent a toner from scattering. The image forming apparatus includes a collecting fan and a blocking device to collect a toner which scatters when a photosensitive body and a developing roller rotate. Air current and air curtain generated by the collecting fan and the blocking device suppress the toner from scattering. Accordingly, malfunction or print failure of the apparatus due to contamination can be prevented and the print speed of image forming apparatus can be increased.

### CROSS-REFERENCE TO RELATED PATENT APPLICATION

This application claims the benefit of Korean Patent Application No. 10-2005-0084646, filed on Sep. 12, 2005, in the Korean Intellectual Property Office, the disclosure of which is incorporated herein by reference in its entirety.

### BACKGROUND OF THE INVENTION

1. Field of the Invention

The present invention relates to an image forming apparatus, and more particularly, to an electrophotographic image forming apparatus which prints an image in high speed using a toner.

2. Description of the Related Art

In general, an electrophotographic image forming apparatus for printing an image on a print medium includes an exposure unit, a photosensitive body, a developing unit, a transfer unit, and a fixing unit. The exposure unit exposes the photosensitive unit and forms an electrostatic latent image corresponding to print data. The developing unit develops the electrostatic latent image to form a toner image. The transfer unit transfers the toner image onto the print medium. The fixing unit applies heat and pressure and fuses the toner image on the print medium.

The developing unit includes a housing for storing a toner and a developing roller for feeding the toner stored in the housing and developing the electrostatic latent image. A developing method is classified into such as a contact developing method and a non-contact developing method. In the contact developing method, the photosensitive body and the developing roller are contacted to each other to form a development nip, and the toner is transferred from the developing roller onto the photosensitive body in the development nip to develop the electrostatic latent image. In the non-contact developing method, the photosensitive body and the developing roller are closely separated from each other by a development gap, and the toner jumps from the developing roller to the photosensitive body by the development gap to develop the electrostatic latent image. For example, a development bias voltage in which a predetermined alternating current voltage overlaps a direct current voltage is applied to the developing roller and the toner jumps toward the electrostatic latent image by an electrostatic force.

The non-contact developing method has an excellent image print quality and high resolution. However, when the toner jumps by the electrostatic force, the toner may not be transferred onto the outer circumferential surface of the photosensitive body. Since the size of the toner particle is small and air current is generated by air resistance when the photosensitive body and the developing roller rotate, the toner scatters. If the rotating speeds of the photosensitive body and the developing roller increase, the image forming apparatus and the print medium are apt to be contaminated due to the toner scattering. This causes malfunction or print failure of the image forming apparatus.

Accordingly, an apparatus was suggested which has a propeller between a photosensitive body and a developing roller and sends scattered toner to a toner collecting bin using air current generated when rotating the propeller. However, in an image forming apparatus for high speed printing an image, since speed of air flow generated when the photosensitive body and the developing roller rotate is high and turbulence flow increases, it is difficult to collect the scattered toner only using a force of the air current generated by the propeller.

### SUMMARY OF THE INVENTION

The present invention provides a high-speed image forming apparatus which efficiently collects a scattered toner to reduce contamination of the inside of the image forming apparatus and a print medium and prevent malfunction and print failure of the apparatus.

According to an aspect of the present invention, there is provided an image forming apparatus including: a photosensitive body on which an electrostatic latent image is formed; a developing unit which has a developing roller for feeding a toner to the electrostatic latent image and stores the toner; a collecting fan which is placed at the downstream side of a development region in which the photosensitive body and the developing roller face each other and generates air current to collect a scattered toner; and a blocking means which forms an air curtain at the downstream side of the collecting fan and blocks air current which scatters the toner to the downstream side of the development region.

The blocking means may include a ventilation fan; and a ventilation path which guides air current generated at the ventilation fan to the direction for blocking the air current which scatters the toner to the downstream side of the development region.

The image forming apparatus may further include a transfer roller which faces the photosensitive body to form a transfer nip; and a guide plate of which one surface guides a print medium conveyed to the transfer nip and the other surface forms the ventilation path to separate the ventilation path from the conveying path of the print medium.

An outlet of the ventilation path may be placed at the downstream side of the collecting fan.

The image forming apparatus may further include a collecting bin having an air inlet for receiving the air current collecting the toner, a toner storing unit which stores the toner collected by the air current, and an air outlet for discharging the air from which the toner is removed.

The image forming apparatus may further include a first side wall for blocking one side of the collecting fan and a collecting fan cover placed at the downstream side of the collecting fan, and the air current generated at the collecting fan may be guided toward the air inlet.

The developing unit may further include a housing for storing the toner and forming the external appearance of the developing unit, and the upstream side of the collecting bin may be covered by the housing.

The collecting fan and the collecting bin may be integrally formed with the developing unit.

According to another aspect of the present invention, there is provided an image forming apparatus in which a development region is formed by a photosensitive body on which an electrostatic latent image is formed and a developing roller for feeding a toner to the electrostatic latent image, and scattering air current which scatters a toner to the downstream side of the development region occurs, including a collecting fan which generates collection air current to collect the scattered toner; and a blocking means which forms an air curtain at the downstream side of the collecting fan, to block the scattering air current.

The blocking means may include a ventilation fan; and a ventilation path which guides air current generated at the ventilation fan to the direction for blocking the air current which scatters the toner.

These and other aspects and salient features of the invention will become apparent from the following detailed description of the invention which, taken in conjunction with the annexed drawings, disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional side view illustrating main portions of an image forming apparatus according to an embodiment of the present invention; and

FIG. 2 is a cross-sectional side view illustrating the operation of a collecting fan and a blocking means according to the embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

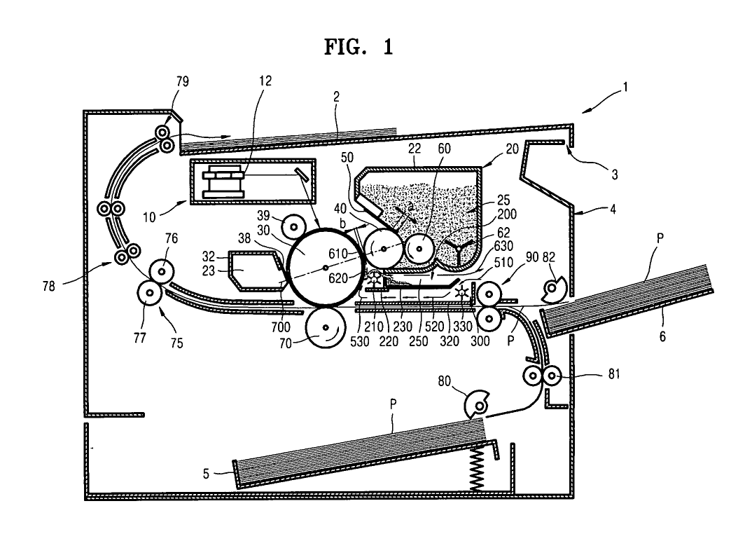

FIG. 1 is a cross-sectional side view illustrating main portions of an electrophotographic image forming apparatus according to an embodiment of the present invention. The electrophotographic image forming apparatus 1 includes a main body 4, a developing unit 20 provided in the main body 4, a photosensitive body 30, a collecting fan 210 for collecting scattered toner particles, and a blocking means for forming air curtain.

A charging bias voltage is applied to a charging roller 39 to charge the outer circumferential surface of the photosensitive body 30 to a uniform potential. For example, the outer circumferential surface of the photosensitive body 30 is uniformly charged to a negative voltage of several hundred volts by a negative charging bias voltage. The exposure unit 10 irradiates light corresponding to image information onto the photosensitive body 30 in accordance with a computer signal and forms an electrostatic latent image on the outer circumferential surface of the photosensitive body 30. Since resistance of a portion onto which the light is irradiated is reduced, negative charges are erased and thus the electrostatic latent image has a negative voltage of several tens of volts or less. The exposure unit 10 includes a light source (not shown) and a deflector 12 for deflecting the light irradiated from the light source.

The developing unit 20 is a cartridge which can be detachably mounted in the main body 4, and includes a housing 22 for storing a toner and forming the external appearance of the developing unit 20, a developing roller 40, a toner layer controlling unit 50, a feeding roller 60, and an agitator 62. A toner storing unit 25 for storing a powdered toner which is a developing agent is provided in the housing 22. When the toner contained in the toner storing unit 25 is used up, the developing unit 20 is replaced with a new developing unit. A door 3 is provided at the side of the main body 4 such that the developing unit 20 is mounted in or dismounted from the main body 4.

The developing roller 40 contacts the toner stored in the housing 22 so that the toner adheres on the outer circumferential surface of the developing roller 40 and feeds the toner to the photosensitive body 30. The developing roller 40 feeds the toner adhered to its outer circumferential surface to the electrostatic latent image formed on the photosensitive body 30 and develops the electrostatic latent image. The electrostatic latent image is developed in a development region in which the photosensitive body 30 and the developing roller 40 face each other. The development region is the development nip or the development gap. A development bias voltage is applied to the developing roller 40 to transfer the toner onto the photosensitive body 30. For example, the development bias voltage is obtained by overlapping a predetermined alternating current voltage with a direct current voltage. Generally, the toner is charged to a negative voltage. The toner which passes through the development region is adhered to only the electrostatic latent image having the negative voltage of several tens of volts or less and is not adhered to a non-image region to which a charging bias voltage is applied. When the development is performed by the non-contact method, the toner having the negative voltage reciprocally vibrates in the development gap (b) to develop the electrostatic latent image.

The feeding roller 60 feeds the toner to the developing roller 40. The agitator 62 agitates the toner such that the toner stored in the toner storing unit 25 does not harden and conveys the toner toward the feeding roller 60.

One side of the toner layer controlling unit 50 is fixed to the housing 22 and the other side thereof contacts the developing roller 40. The toner layer controlling unit 50 controls the thickness of the toner adhering to the outer circumferential surface of the developing roller 40 and charges the toner to a predetermined polarity (for example, an negative voltage) by a frictional contact. The toner layer controlling unit 50 is made of an elastic and flexible metal plate, which elastically contacts the outer circumferential surface of the developing roller 40.

A free end portion (a) is also formed at the other end of the toner layer controlling unit 50. The thickness of the toner layer is determined by the length from a contact point between the toner layer controlling unit 50 and the developing roller 40 to the free end portion (a).

The photosensitive body 30 is a cylindrical metal drum having a photoconductive material layer coated on its outer circumferential surface by a deposition method. A portion of the outer circumferential surface of the photosensitive body 30 is exposed to the print medium. The exposed portion of the outer circumferential surface of the photosensitive body 30 faces the transfer roller 70.

A cleaning member 38 is mounted on a waste toner container 32. The cleaning member 38 contacts the photosensitive body 30 with a predetermined pressure such that the toner remaining on the photosensitive body 30 is removed after transferring. The waste toner container 32 includes a waste toner storing unit 23. The waste toner storing unit 23 stores the toner removed from the photosensitive body 30 by the cleaning member 38.

The transfer roller 70 faces the outer circumferential surface of the photosensitive body 30. The transfer roller 70 transfers the toner image from the outer circumferential surface of the photosensitive body 30 onto the print medium P. The transfer bias voltage having a polarity opposite to that of the toner image is applied to the transfer roller 70. The toner image is transferred onto the print medium P such as paper by an electrostatic force generated between the photosensitive body 30 and the transfer roller 40.

The fixing unit 75 includes a heating roller 76 and a pressure roller 77, which face each other, and applies heat and pressure to the toner image transferred onto the print medium P, and fuses the toner image on the print medium P. The heating roller 76 is a heating source for permanently fixing the toner image and includes a heating coil or a halogen lamp. The pressure roller 77 applies the pressure to the print medium P passing through a fixing nip.

A decurling unit 78 removes curl generated in the print medium P by the heat and pressure of the fixing unit 75. An ejection roller 79 ejects the print medium P to the outside of the image forming apparatus 1. The print medium P ejected from the image forming apparatus 1 is loaded on an ejection tray 2.

Sheet feed cassettes 5 and 6 store the print medium P. Pickup rollers 80 and 82 pick up the print medium P stored in the sheet feed cassettes 5 and 6 one by one. A feed roller 81 conveys the picked-up print medium P toward an aligner 90. The aligner 90 aligns the front end of the print medium P such that the toner image can be transferred onto a desired portion of the print medium P, before the print medium P passes through the contact surface between the photosensitive body 30 and the transfer roller 70.

Although not shown, for electrophotographic multi-color printing, a plurality of developing cartridges are needed. For example, a multi-pass type image forming apparatus includes one photosensitive body and four developing cartridges. In this image forming apparatus, four developing cartridges of cyan, magenta, yellow, and black are included and four cycles of exposing, photosensitizing, and developing processes are sequentially performed for each image, thereby forming a multi-color image. A single-pass type image forming apparatus includes four developing cartridges and four photosensitive bodies corresponding to four colors. In this image forming apparatus, since exposing, photosensitizing, and developing processes are performed at once for each color, a rapid print speed can be realized. A two-pass type image forming apparatus is a combination of the multi-pass type and the single-pass type, and includes two units each of which includes two developing cartridges and one photosensitive body.

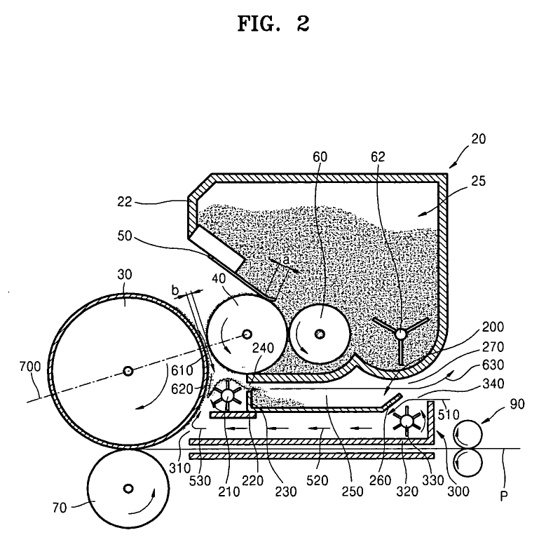

FIG. 2 is a cross-sectional side view illustrating the operation of a collecting fan and a blocking means according to the embodiment of the present invention. Referring to FIGS. 1 and 2, the collecting fan and the blocking means are shown.

The collecting fan 210 is provided at the discharging side of the photosensitive body 30 and the developing roller 40 and collects the scattered toner. A collecting bin 200 for receiving the collected toner may be further included. Here, the discharging side of the photosensitive body 30 and the developing roller 40 represents a downstream side of the development region in which the photosensitive body 30 and the developing roller 40 face each other. As described above, the development region is defined by the development nip or the development gap.

When developing the electrostatic latent image, the rotating directions of the photosensitive body 30 and the developing roller 40 are opposite to each other as indicated by the respective arrows. When the photosensitive body 30 and the developing roller 40 rotate in the directions shown in FIG. 2, the discharging side of the photosensitive body 30 and the developing roller 40 is the side lower than an imaginary surface indicated by line 700 which passes through and connects the center of the photosensitive body 30 with the center of the developing roller 40. When the photosensitive body 30 and the developing roller 40 rotate, scattering air current 610 causes scattering of the toner. The resistance and friction between the air and the surfaces of the photosensitive body 30 and the developing roller 40 generated an air current toward the discharging side of the development region. The toner which is not transferred onto the electrostatic latent image is scattered by the scattering air current 610. The collecting fan 210 generates a collection air current 620 which returns the scattered toner toward the imaginary surface 700. The collecting fan 210 changes the direction of the scattering air current 610 to the collection air current 620.

The collecting bin 200 collects the toner contained in the collection air current 620. For example, the collecting bin 200 includes a first side wall 230, a second side wall 260, a collecting fan cover 220, and a toner storing unit 250. The upper side of the collecting bin 200 may be covered by the housing 22 of the developing unit 20. The first side wall 230 is placed at one side of the collecting bin 200 and concentrates air flow generated by the collecting fan 210 to the imaginary surface 700. For example, an air inlet 240 for introducing the collection air current 620 is provided between the first side wall 230 and the housing 22. The second side wall 260 is provided at the other end of the collecting bin 200. An air outlet 270 for discharging air current 630 to the outside of the toner storing unit 250 is provided between the second side wall 260 and the housing 22. The collection air current 620 enters into the toner storing unit 250 through the air inlet 240 to deposit the toner into the toner storing unit 250. The air current 620 then exits the toner storing unit 250 through the air outlet 270 by the air current 630. The toner contained in the collection air current 620 is deposited into the toner storing unit 250 by its own weight since the speed of the collection air current 620 slows down as the air current enters the storing unit 250. However, the present invention is not limited to this structure, and various embodiments for filtering the toner contained in the collection air current 620 and depositing the toner into the toner storing unit 250 can be embodied. The collecting fan cover 220 covers the downstream side of the collecting fan 210. The collecting fan cover 220 prevents the toner from flowing into the conveying path of the print medium due to rotation or gravity and concentrates the air current generated when the collecting fan 210 rotates toward the imaginary surface 700. For example, the collecting fan 210 and the collecting bin 200 may be integrally formed with the developing unit 20. When the developing unit 20 is dismounted from the main body 4, the toner contained in the toner storing unit 250 can be easily removed or the collecting fan 210 can be easily repaired.

If the rotating speeds of the photosensitive body 30 and the developing roller 40 increase, the degree of contamination caused by the toner scattering is more excessive. If the photosensitive body 30 and the developing roller 40 rotate at high speed, the scattering air current 610 has a high speed and creates a strong turbulence. The scattering air current 610 may contaminate the main body 4 although the collecting fan 210 rotates. Accordingly, the blocking means forms an air curtain 530 by increasing a downstream air pressure of the collecting fan 210. The air curtain 530 prevents the scattering air current 610 from moving from the collecting fan 210 to the downstream side and changes the moving direction to a direction of the collection air current 620. The changed path of the collection air current 620 is described above. The transfer roller 70 and the photosensitive body 30 face each other to form a transfer nip. The transferring process is performed in the transfer nip. The blocking means is provided in the conveying path of the print medium P conveyed to the transfer nip. For example, the blocking means may be provided between the transfer nip and the aligner 90 for aligning the front end of the print medium P. The blocking means includes a ventilation fan 330 and a ventilation path 300 for guiding the air current from the ventilation fan 330 to the downstream side of the collecting fan 210. The inlet 340 of the ventilation path 300 includes the ventilation fan 330, and the outlet 310 of the ventilation path 300 is placed at the downstream side of the collecting fan 210. The air flow out of the outlet 310 of the ventilation path 300 forms the air curtain 530 at the downstream side of the collecting fan 210. For example, the ventilation path is formed by a guide plate 320. The guide plate 320 separates the conveying path of the print medium P from the ventilation path 300. For example, the ventilation path 300 is provided between the upstream side of the guide plate 320 and the downstream side of the collecting bin 200. Air current 510 generated by the ventilation fan 330 becomes air current 520 which flows in the upstream side of the guide plate 320 and the downstream side of the collecting bin 200 and forms the air curtain 530 at the outlet 310 of the ventilation path 300. The downstream side of the guide plate 320 forms the conveying path of the print medium P and guides the print medium P conveyed to the transfer nip.

As described above, according to the image forming apparatus of the present invention, since the toner is prevented from scattering by air current generated at a collecting fan and a blocking means, contamination, malfunction, and print failure of the image forming apparatus are prevented and the print speed of image forming apparatus can increase.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
a photosensitive body on which an electrostatic latent image is formed;
a developing unit having a developing roller for feeding a toner to the electrostatic latent image and stores the toner;
a collecting fan positioned at a downstream end of a development region in which the photosensitive body and the developing roller face each other, the collection fan generating air current to collect scattered toner from said photosensitive body and said developing roller; and
a blocking device for forming an air curtain at a downstream end of the collecting fan and blocking said air current which scatters the toner to the downstream end of the development region.

2. The image forming apparatus according to claim 1, wherein the blocking device comprises:
a ventilation fan; and
a ventilation path which guides air current generated by the ventilation fan to the direction for blocking the air current which scatters the toner to the downstream end of the development region.

3. The image forming apparatus according to claim 2, further comprising:
a transfer roller which faces the photosensitive body to form a transfer nip; and
a guide plate having a surface to guide a print medium conveyed to the transfer nip and a second surface forming the ventilation path to separate the ventilation path from the conveying path of the print medium.

4. The image forming apparatus according to claim 3, wherein an outlet of the ventilation path is positioned at the downstream end of the collecting fan.

5. The image forming apparatus according to claim 4, further comprising a collecting bin having an air inlet for receiving the air current collecting the toner, a toner storing unit which stores the toner collected by the air current, and an air outlet for discharging the air from which the toner is removed.

6. The image forming apparatus according to claim 5, further comprising a first side wall for blocking one side of the collecting fan and a collecting fan cover placed at the downstream end of the collecting fan,
wherein air current generated by the collecting fan is guided toward the air inlet.

7. The image forming apparatus according to claim 6, wherein the developing unit further has a housing for storing the toner and forming the external appearance of the developing unit,
wherein the upstream end of the collecting bin is covered by the housing.

8. The image forming apparatus according to claim 7, wherein the collecting fan and the collecting bin are integrally formed with the developing unit.

9. An image forming apparatus in which a development region is formed by a photosensitive body on which an electrostatic latent image is formed and a developing roller for feeding a toner to the electrostatic latent image, and which creates a scattering air current which scatters a toner to a downstream end of the development region, comprising:
a collecting fan which generates a collection air current to collect the scattered toner; and
a blocking device which forms an air curtain at a downstream end of the collecting fan, to block the scattering air current.

10. The image forming apparatus according to claim 9, wherein the blocking device comprises:
a ventilation fan; and
a ventilation path which enables air current generated by the ventilation fan to a direction for blocking the air current which scatters the toner.

11. The image forming apparatus of claim 10, wherein the apparatus includes a housing defining said ventilation path and collecting path having a collecting bin.

12. The image forming apparatus of claim 11, wherein the air current directs loose scattered toner particles from the development region to said collecting path.

13. The image forming apparatus of claim 11, wherein said air current generated from said ventilation fan directs scattered toner particles from said development region away from a print medium toward said collecting path.

14. The image forming apparatus of claim 11, wherein said collection air current directs scattered toner particles along said collecting path and where said collecting path has an air inlet to receive said collection air current and an air outlet spaced from said air inlet.

15. The method of recovering toner scattered from a development region between a photosensitive body for forming an electrostatic latent image and a developing roller of an image forming apparatus, said method comprising:
directing a collection air current toward said development region and directing scattered toner to a collecting bin; and
directing an air curtain toward said collection air current to direct said scattered toner toward said collecting bin.

16. The method of claim 15, wherein said image forming apparatus further comprises a collecting fan positioned near said development region and where said collecting fan produces said collection air current.

17. The method of claim 16, wherein said image forming apparatus includes a device for generating said air curtain, said method comprising directing said air curtain toward said photosensitive body and toward said collecting fan.

18. The method of claim 15, comprising directing said air curtain in a direction opposite a scattering direction of said toner and directing said toner to said collection bin.

19. The method of claim 18, further comprising said collection air current directing through a collection channel, and reducing the velocity of said collection air current to deposit said toner into said collecting bin.

20. The method of claim 18, wherein said image forming apparatus includes a transfer roller positioned to form a transfer nip between the photosensitive body and the transfer roller, and a guide plate for guiding a print medium through the transfer nip, said method comprising directing said air current in a direction to inhibit scattered toner from contacting said print medium.
